(19) United States
(12) Patent Application Publication
(10) Pub. No.: US 2015/0080128 A1
(43) Pub. Date: Mar. 19, 2015

(54) CONTENT MANAGEMENT SYSTEM

(71) Applicant: Zynga Inc., San Francisco, CA (US)

(72) Inventors: Robert Marshall Terrell, IV, Mill Valley, CA (US); Brian Apgar, Eugene, OR (US)

(21) Appl. No.: 14/489,092

(22) Filed: Sep. 17, 2014

Related U.S. Application Data
(60) Provisional application No. 61/879,402, filed on Sep. 18, 2013.

(51) Int. Cl. A63F 13/65; A63F 13/35; H04L 29/08

(52) U.S. Cl. CPC A63F 13/65; H04L 67/10; A63F 13/35
USPC 463/31; 463/42

(57) ABSTRACT

A system, computer-readable storage medium storing at least one program, and a computer-implemented method for a content management system that receives an update to a value in at least one cell of a table in an editable document. Each cell of the table maps to a property of a class definition for a game asset of a virtual online game. The content management system modifies a property of the class definition that maps to a cell that received the update to the value. The content management system serializes data representative of the modified property. The content management system sends the serialized data to a client system for instantiation of the game asset having the modified property.

### CROSS REFERENCE TO RELATED APPLICATION

This application claims the benefit of co-pending U.S. Provisional Application No. 61/879,402, filed Sep. 18, 2013, which is hereby incorporated herein by reference in its entirety.

### TECHNICAL FIELD

The subject matter disclosed herein generally relates to the processing of data. Specifically, the present disclosure addresses systems and methods for processing data in a game.

### BACKGROUND

Many traditional online games may be developed using a game engine. In general, a game engine may be a module that game developers use to create games for video game consoles, mobile devices, and personal computers. A core functionality typically provided by traditional game engines include a rendering engine (“renderer”) for 2D or 3D graphics, a physics engine or collision detection (and collision response), sound, scripting, animation, artificial intelligence, networking, streaming, memory management, threading, localization support, a scene graph, and the like.

Recently, the process of developing a game is economized, at least in part, by the advent of third party game engines that game developers may purchase and configure for use of their game. In this way, game developers may reuse or adapting or configuring the same game engine to create different games, or to make it easier to “port” games to multiple platforms.

### SUMMARY

Example systems and methods of providing a content management system are provided. In the following description, for purposes of explanation, numerous specific details are set forth in order to provide a thorough understanding of example embodiments. It will be evident, however, to one skilled in the art that the described systems and methods may be practiced without these specific details

A system, computer-readable storage medium storing at least one program, and a computer-implemented method for a content management system that receives an update to a value in at least one cell of a table in an editable document. Each cell of the table maps to a property of a class definition for a game asset of a virtual online game. The content management system modifies a property of the class definition that maps to a cell that received the update to the value. The content management system serializes data representative of the modified property. The content management system sends the serialized data to a client system for instantiation of the game asset having the modified property.

In various embodiments, the content management system comprises an editor tool, a spreadsheet value database, class definition data storage and serialized data storage. The content management system further comprises a content management interface that provides access to the editor tool, the spreadsheet value database, the class definition data storage and the serialized data storage.

The spreadsheet value database includes one or more values that can be accessed for populating respective cells of one or more editable spreadsheet documents. The content management system allows for multiple, different spreadsheet formats to access the values in the spreadsheet value database and populate each spreadsheet with the accessed values. This means that multiple user can view the values from differently formatted spreadsheets. The editor tool also comprises spreadsheet format that is native to the content management system.

Each game asset that is rendered in a virtual online game is defined according to one or more class definitions in the class definition data storage. A class definition defines one or more properties of the game asset. For example, a game asset may be a dialog message box that appears within the virtual online game. The dialog message box may have a plurality of properties, such as a background image, text and action that is to be triggered in response to receipt of a user action. Other non-limiting examples of a property may be a color, a cost value, a rate of appearance of the game asset in the virtual online game, etc.

When the cells of an instance of an editable spreadsheet document are populated with values from the spreadsheet value database, the content management system maps each property in the class definition to a respective cell. The instance of an editable spreadsheet document allows for users to update the values. When the content management system detects an updated value, the content management system serializes the updated value and stores the serialized updated value in the serialized data storage. Serializing the updated value converts the updated value to a format that is compatible with a client device at run-time. The client device requests the serialized updated value from the content management system and the content management system sends the serialized updated value to the client device.

According to one embodiment, the content management system detects that a value in a cell has been updated in a spreadsheet. The cell maps to an image property of a class for a game asset. The updated value is a uniform resource locator (URL) of an image. The content management system serializes the URL as being mapped to the image property. The serialized URL is in a format that is compatible with the client device. The client device requests and receives the serialized URL from the content management system. At run-time, the client device accesses the image at the URL and downloads the image. The client device renders an instance of the game assets by using the downloaded image.

Some example embodiments may provide a game development system that allows game designers to manage the game assets of a game. As used herein, a game asset may refer to a class or type of object that may be part of a game. By way of example and not limitation, a type of virtual animal, crop, building, weapon, vehicle, character, sound, inventory item, land expansion, obstacle, quest, and the like are all example of different types of game assets.

In some cases, a content management interface may be communicatively coupled to a game engine, such as UNITY®, as developed by UNITY TECHNOLOGIES. The content management interface may provide a user interface to the user for managing the game assets of a game. For example, and not limitation, the content management interface may allow a game developer to configure game properties associated with a game asset, such as a name, graphical image or icon, description, purchase cost, level unlock, growth time, construction time, feeding requirement, and the like.

In some embodiments, the content management interface may link a class definition of a game asset with an editable document. The editable document may include a table where the columns of the table correspond to properties defined by the class definition. Upon detecting a user initiated edit to one of the properties in the table of the editable document, the content management interface may then edit a value of the property of the class definition. A game engine may then use the class definition with the edited value in the execution of the game.

These and other embodiments are described in greater below.

### BRIEF DESCRIPTION OF THE DRAWINGS

The present disclosure is illustrated by way of example, and not limitation, in the figures of the accompanying drawings, in which like reference numerals indicate similar elements unless otherwise indicated.

FIG. 1 illustrates an example of a system for implementing various disclosed embodiments.

FIG. 2 illustrates an example social network, according to an example embodiment.

FIG. 3 is a block diagram illustrating example modules and operations of a content management game system, according to an example embodiment.

FIG. 4 is a flowchart showing an example method of updating a property of a class definition, according to some example embodiments.

FIG. 4 illustrates an example data flow in a system, according to an example embodiment.

FIG. 5 illustrates an example network environment, according to an example embodiment.

FIG. 6 illustrates an example computing system architecture, according to an example embodiment.

FIG. 7 illustrates an example computing system architecture, which may be used to implement a server or a client system.

### DESCRIPTION OF EXAMPLE EMBODIMENTS

### Example System

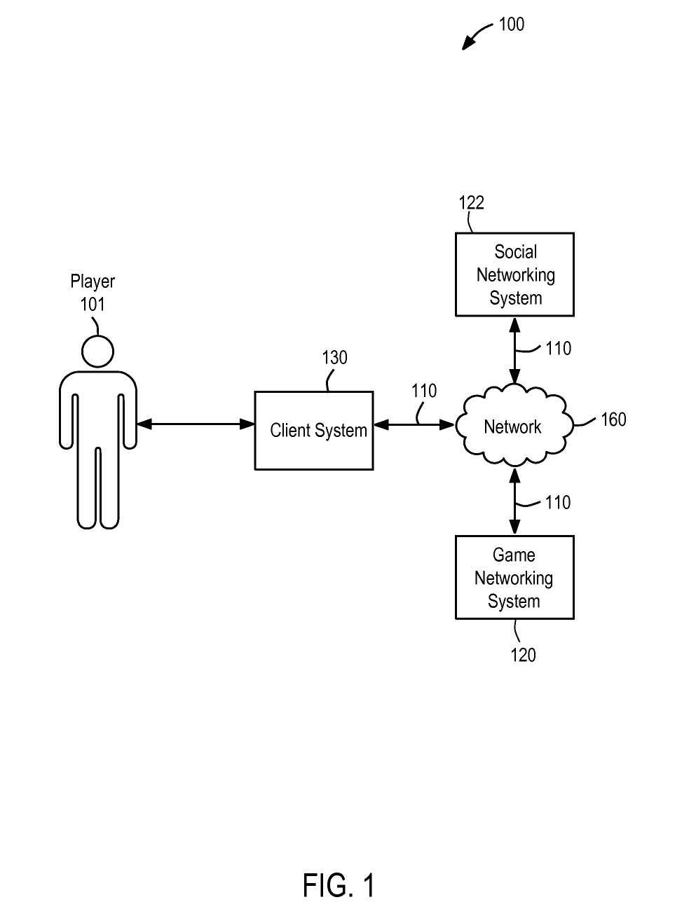

FIG. 1 illustrates an example of a system for implementing various disclosed embodiments. In particular embodiments, system 100 comprises player 101, social networking system 122, game networking system 120, client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 122 is a network-addressable computing system that can host one or more social graphs. Social networking system 122 can generate, store, receive, and transmit social networking data. Social networking system 122 can be accessed by the other components of system 100 either directly or via network 160. Game networking system 120 is a network-addressable computing system that can host one or more online games. Game networking system 120 can generate, store, receive, and transmit game-related data, such as, for example, game account data, game input, game state data, and game displays. Game networking system 120 can be accessed by the other components of system 100 either directly or via network 160. Player 101 may use client system 130 to access, send data to, and receive data from social networking system 122 and game networking system 120. Client system 130 can access social networking system 122 or game networking system 120 directly, via network 160, or via a third-party system. As an example and not by way of limitation, client system 130 may access game networking system 120 via social networking system 122. Client system 130 can be any suitable computing device, such as a personal computer, laptop, cellular phone, smart phone, computing tablet, and the like.

Although FIG. 1 illustrates a particular number of players 101, social networking systems 122, game networking systems 120, client systems 130, and networks 160, this disclosure contemplates any suitable number of players 101, social networking systems 122, game networking systems 120, client systems 130, and networks 160. As an example and not by way of limitation, system 100 may include one or more game networking systems 120 and no social networking systems 122. As another example and not by way of limitation, system 100 may include a system that comprises both social networking system 122 and game networking system 120. Moreover, although FIG. 1 illustrates a particular arrangement of player 101, social networking system 122, game networking system 120, client system 130, and network 160, this disclosure contemplates any suitable arrangement of player 101, social networking system 122, game networking system 120, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, or another type of connection, or a combination of two or more such connections. Connections 110 need not necessarily be the same throughout system 100. One or more first connections 110 may differ in one or more respects from one or more second connections 110. Although FIG. 1 illustrates particular connections between player 101, social networking system 122, game networking system 120, client system 130, and network 160, this disclosure contemplates any suitable connections between player 101, social networking system 122, game networking system 120, client system 130, and network 160. As an example and not by way of limitation, in particular embodiments, client system 130 may have a direct connection to social networking system 122 or game networking system 120, bypassing network 160.

### Online Games and Game Systems

In an online computer game, a game engine manages the game state of the game. Game state comprises all game play parameters, including player character state, non-player character (NPC) state, in-game object state, game world state (e.g., internal game clocks, game environment), and other game play parameters. Each player 101 controls one or more player characters (PCs). The game engine controls all other aspects of the game, including non-player characters (NPCs), and in-game objects. The game engine also manages game state, including player character state for currently active (online) and inactive (offline) players.

An online game can be hosted by game networking system 120, which can be accessed using any suitable connection with a suitable client system 130. A player 101 may have a game account on game networking system 120, wherein the game account can contain a variety of information associated with the player 101 (e.g., the player's personal information, financial information, purchase history, player character state, game state). In some embodiments, the player 101 may play multiple games on game networking system 120, which may maintain a single game account for the player 101 with respect to all the games, or multiple individual game accounts for each game with respect to the player 101. In some embodiments, game networking system 120 can assign a unique identifier to each player 101 of an online game hosted on game networking system 120. Game networking system 120 can determine that a player 101 is accessing the online game by reading the user's cookies, which may be appended to HTTP requests transmitted by client system 130, and/or by the player 101 logging onto the online game.

In particular embodiments, player 101 may access an online game and control the game's progress via client system 130 (e.g., by inputting commands to the game at the client device). Client system 130 can display the game interface, receive inputs from player 101, transmit user inputs or other events to the game engine, and receive instructions from the game engine. The game engine can be executed on any suitable system (such as, for example, client system 130, social networking system 122, or game networking system 120). As an example and not by way of limitation, client system 130 can download client components of an online game, which are executed locally, while a remote game server, such as game networking system 120, provides backend support for the client components and may be responsible for maintaining application data of the game, processing the inputs from the player 101, updating and/or synchronizing the game state based on the game logic and each input from the player 101, and transmitting instructions to client system 130. As another example and not by way of limitation, each time player 101 provides an input to the game through the client system 130 (such as, for example, by typing on the keyboard or clicking the mouse of client system 130), the client components of the game may transmit the player's input to game networking system 120.

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and so forth. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player 101.

In particular embodiments, player 101 may access particular game instances of an online game. A game instance is a copy of a specific game play area that is created during runtime. In particular embodiments, a game instance is a discrete game play area where one or more players 101 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 101 and one or more in-game objects controlled by the game engine. When accessing an online game, the game engine may allow player 101 to select a particular game instance to play from a plurality of game instances. Alternatively, the game engine may automatically select the game instance that player 101 will access. In particular embodiments, an online game comprises only one game instance that all players 101 of the online game can access.

In particular embodiments, a specific game instance may be associated with one or more specific players 101. A game instance is associated with a specific player 101 when one or more game parameters of the game instance are associated with the specific player 101. As an example and not by way of limitation, a game instance associated with a first player 101 may be named “First Player's Play Area.” This game instance may be populated with the first player's PC and one or more in-game objects associated with the first player 101. In particular embodiments, a game instance associated with a specific player 101 may only be accessible by that specific player 101. As an example and not by way of limitation, a first player 101 may access a first game instance when playing an online game, and this first game instance may be inaccessible to all other players 101. In other embodiments, a game instance associated with a specific player 101 may be accessible by one or more other players, either synchronously or asynchronously with the specific player's game play. As an example and not by way of limitation, a first player 101 may be associated with a first game instance, but the first game instance may be accessed by all first-degree friends in the first player's social network. In particular embodiments, the game engine may create a specific game instance for a specific player 101 when that player 101 accesses the game. As an example and not by way of limitation, the game engine may create a first game instance when a first player 101 initially accesses an online game, and that same game instance may be loaded each time the first player 101 accesses the game. As another example and not by way of limitation, the game engine may create a new game instance each time a first player 101 accesses an online game, wherein each game instance may be created randomly or selected from a set of predetermined game instances. In particular embodiments, the set of in-game actions available to a specific player 101 may be different in a game instance that is associated with that player 101 compared to a game instance that is not associated with that player 101. The set of in-game actions available to a specific player in a game instance associated with that player 101 may be a subset, superset, or independent of the set of in-game actions available to that player 101 in a game instance that is not associated with him. As an example and not by way of limitation, a first player 101 may be associated with Blackacre Farm in an online farming game. The first player 101 may be able to plant crops on Blackacre Farm. If the first player 101 accesses a game instance associated with another player 101, such as Whiteacre Farm, the game engine may not allow the first player 101 to plant crops in that game instance. However, other in-game actions may be available to the first player 101, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, and the like). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure includes any suitable social graph users.

The minimum number of edges required to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N−1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nₘₐₓ degrees of the player, where Nₘₐₓ is the maximum degree of separation allowed by the system managing the social graph (such as, for example, social networking system 122 or game networking system 120). In one embodiment, Nₘₐₓ equals 1, such that the player's social network includes only first-degree friends. In another embodiment, Nₘₐₓ is unlimited and the player's social network is coextensive with the social graph.

In particular embodiments, the social graph is managed by game networking system 120, which is managed by the game operator. In other embodiments, the social graph is part of a social networking system 122 managed by a third-party (e.g., Facebook®, Friendster, Myspace). In yet other embodiments, player 101 has a social network on both game networking system 120 and social networking system 122, wherein player 101 can have a social network on the game networking system 120 that is a subset, superset, or independent of the player's social network on social networking system 122. In such combined systems, game network system 120 can maintain social graph information with edge type attributes that indicate whether a given friend is an “in-game friend,” an “out-of-game friend,” or both. The various embodiments disclosed herein are operable when the social graph is managed by social networking system 122, game networking system 120, or both.

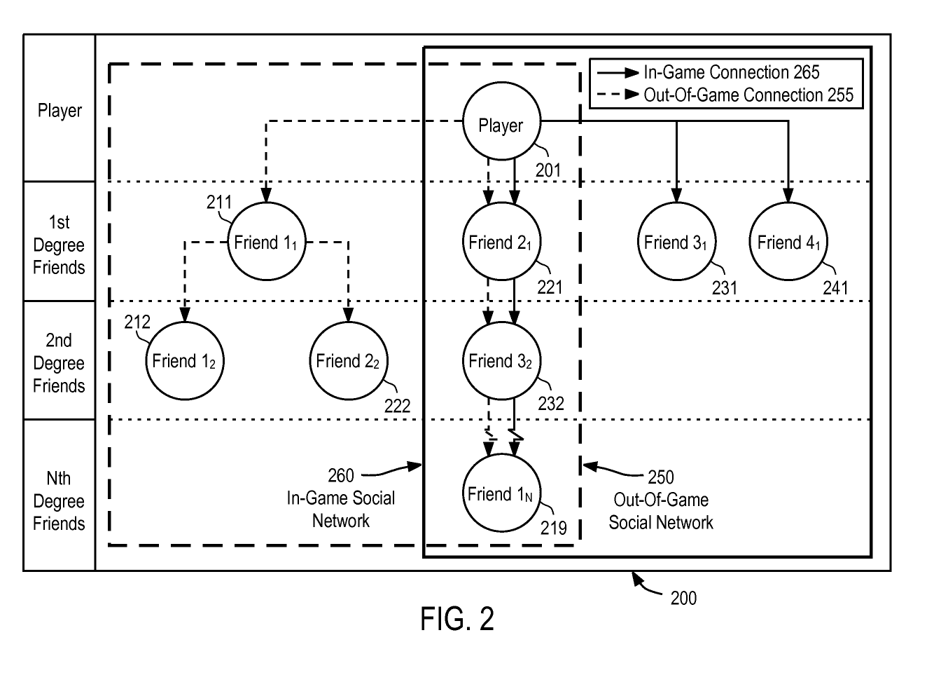

FIG. 2 shows an example of a social network within a social graph, according to an example embodiment. As shown, Player 201 can be associated, connected or linked to various other users, or “friends,” within the social network 250. These associations, connections or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of social network 250 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 122.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out of game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access in-game social network 260, out-of-game social network 250, or both.

In particular embodiments, the connections in a player's in-game social network can be formed both explicitly (e.g., users must “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in disintermediated interactions or the like), but that could be the case.

### Example Modules of a Content Management System

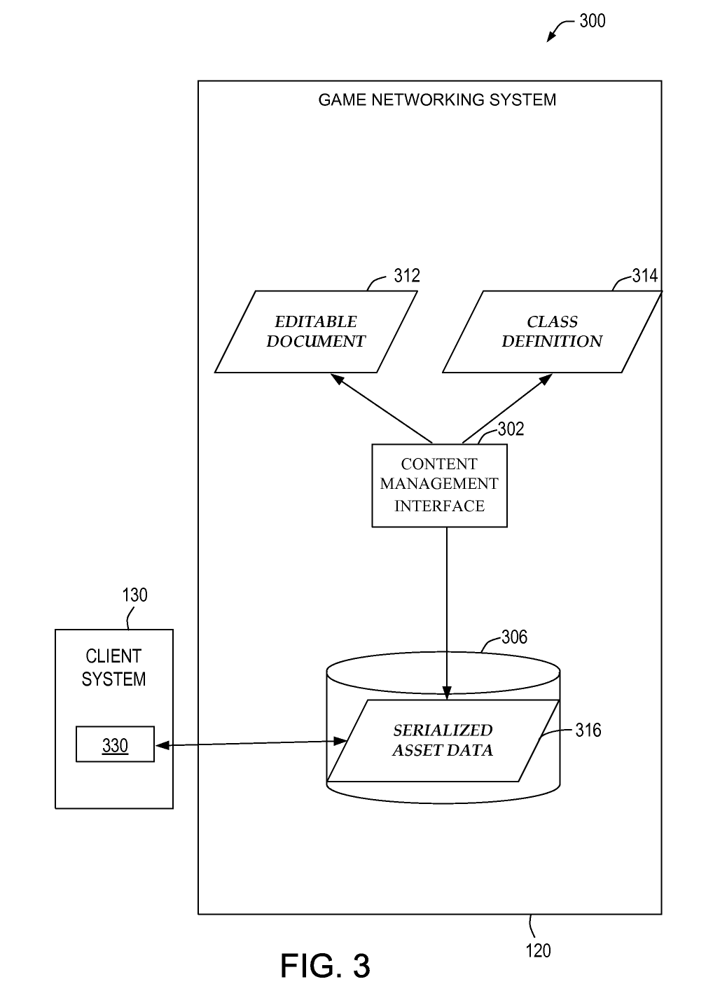

FIG. 3 is a block diagram illustrating example modules and operations of a content management game system 300, according to an example embodiment. As described herein, the content management game system 300 facilitates management of assets utilized by a game system. As FIG. 3 illustrates, the content management game system 300 involves the interactions of modules of the client system 130 and the game networking system 120 of FIG. 1.

For example, the client system 130 may include a game client 330. The game client 330 may include a game engine (e.g., UNITY®) that consumes the game assets generated by the game networking system 120 as part of a process for executing a game on the client system 130. Processing the game assets may involve rendering images of the game assets and performing game logic to provide the functionality and game mechanics of a game.

With respect to the game networking system 120, FIG. 3 shows that the game networking system 120 may include a content management interface 302 the processes an editable document 312 and a class definition 314. The editable document 312 may be a document that is in a form that some game developers find convenient. For example, in many cases, the editable document 312 may be an EXCEL workbook or a WORD document that includes a table that maps to properties of the class definition 314. In turn, the class definition 314 may be a document that specifies a software construct, such as a class definition. The class definition may define properties (e.g., data fields) and methods (e.g., operations) that are part of a type of a software-implemented module.

As just described, properties specified by the class definition 314 may map to parts of the editable document. For example, where the editable document 312 includes a table, the properties may map to the columns of the table.

In operation, a game developer may update the values for particular properties in a class definition through the content management interface 302. For example, the content management interface 302 may display a representation of the table of the editable document and provide facilities for the game developer to update, add, remove, etc. the values associated with the properties. Responsive to receiving the update to the property of the class definition 314, the update the updated values to the class definition 314 or to a run-time database 306. The runtime data base 306 may store serialized data 316 representing the game assets of a game. For example, where a game asset represents a crop, the class definition may include an icon property to represent the image or icon of the crop. The icon property may map to a column in the editable document 312. And the game developer may update the value for the icon property (e.g., a url to an image file), which the content management interface 302 serializes to the run-time database 306. Once the value is serialized to the run-time database 306, the game client 330 executing on the client system 130 may access the serialized asset data 316 to obtain render and process the game asset (e.g., the crop game asset) as part of the execution of the game.

These example embodiments draw from game data stored in designer-friendly Excel files, which the Content management system parses and compiles into binary Protocol Buffers for deployment. The Content management system provides GUI data editor in Unity that allows designers to make and test changes, even while the game is running The Content management system is smart enough to preserve Excel formulas across edits and ignore extraneous columns.

Some game designers prefer to work in certain file formats (e.g., Excel) because it allows them to rapidly create large amounts of content, or use formulas to balance huge swaths of game content at a time. Likewise, other game designers like to work inside the game, pushing new values and testing them inside the game itself. One important goal of this framework is to enable both modes of working. The Content management system includes spreadsheet-like editor windows with powerful editing features (filtering, sorting, CRUD) with the data itself stored in Excel XML files. Edits can be made either in the Unity editor while the game is being played or in Excel. Formulas are detected and not overwritten, and columns not used in the data model are ignored. Edits made in Unity are pushed into the live game, so data changes can be tested immediately. All game data is stored in binary protocol buffer files. Protocol buffers are designed to be forward-compatible (i.e. fields can be added or removed without breaking code).

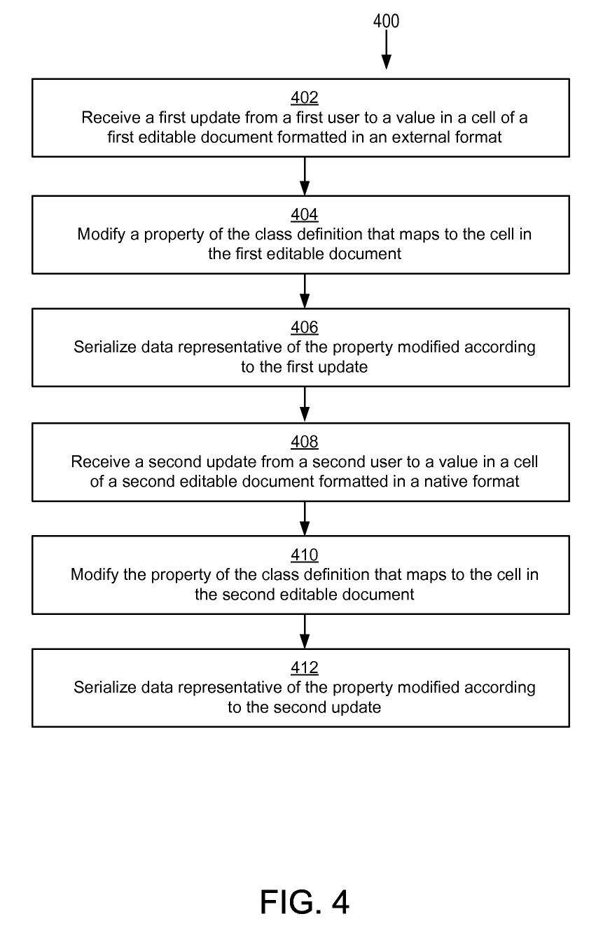

FIG. 4 is a flowchart showing an example method 400 of updating a property of a class definition, according to some example embodiments.

At operation 402, the content management system receives a first update from a first user to a value in a cell of a first editable document formatted according to an external format. In some embodiments, the content management system receives a request to populate a spreadsheet formatted according to an external format with values from the spreadsheet value database. An external format can be a format defined by a third party, such as EXCEL. In response to the request, the content management system accesses the values and sends the values to the source of the request in order to populate the first editable document with the values. The first user provides a first update to a value in a cell in the first editable document.

At operation 404, the content management system modifies a property of a class definition that maps to the cell in the first editable document. The class definition is stored in the class definition data storage. The class definition has a plurality of properties and each property maps to a cell in the first editable document. Based on the first update, the content management system modifies a particular property that corresponds to the cell in the first editable document. The modified particular property is stored in the class definition data storage.

At operation 406, the content management system serializes data representative of the property modified according to the first update. The content management system converts the modified particular property in the class definition data storage into a format that is compatible with a client system at run-time. The content management system stores the serialized data in the serialized data storage.

At operation 408, the content management system receives a second update from a second user to the first update in a cell of a second editable document formatted according to a native format. The content management system receives a request to populate a spreadsheet formatted according to a native format with values from the spreadsheet value database. A native format can be a format defined by an editor tool of the content management system. In response to the request, the content management system accesses the values and sends the values to the source of the request in order to populate the second editable document with the values. The second user provides a second update to a value in a cell in the second editable document.

At operation 410, the content management system modifies a property of class definition that maps to the cell in the second editable document. Based on the second update, the content management system again modifies the particular property since it corresponds to the cell in the second editable document. The modified particular property is stored in the class definition data storage, replacing the previously-stored update received from the first user.

At operation 412, the content management system serializes data representative of the property modified according to the second update. The content management system converts the modified particular property in the class definition data storage into a format that is compatible with a client system at run-time. The content management system stores the serialized data in the serialized data storage—replacing the previously-stored serialized data representative of the first update from the first user.

### Overview of Content Management System

Example embodiments add the ability to edit Excel spreadsheets in Unity, which allows game developers to more conveniently validate data as it's being added/updated. Columns can be given types, such as booleans, complex expressions, C# enums, references to other spreadsheet columns, etc.

Existing editors can be opened in Unity under the Storyville menu, such as Quest Editor, Inventory Editor, etc.

Spreadsheets are exported to the ProtoDB.bytes file before running the game. The copy is primarily done using reflection by matching spreadsheet column names to ProtoDB field names. For any ProtoDB fields that don't line up 1-to-1 with the spreadsheet, each spreadsheet class can override a ‘CustomExport’ function to initialize the ProtoDB objects manually. See the QuestListData.CustomExport method for an example.

### Column Types

You can assign special types to a column by clicking on the “Edit Columns” button on the editor's button bar.
FileName
   A filename column will display a file picking interface on the GUI. It will show thumbnails for supported file types.
   To set a column up in this manner, set its ‘Filename Ext’ to the file extension (such as ‘png’), and its ‘Filename Path’ to the relative folder, such as ‘Textures/UI/Craftables’.
Expression
   An expression column will show each cell with a foldout arrow. Clicking on the arrow will pop up an expression editor window which will help users create valid expressions.
Reference
   A reference column will show each cell as a drop-down selector. The selector gets its list from a different column in any valid Excel file.
   To set a column up in this manner, set its ‘Reference’ using one of the following formats:
      filename:table:column
      :table:column (leaving out the spreadsheet before the first colon means to use the current file)
      filename:column (uses the first table in the file)
      column (uses a different column in the same table)
   Where:
      filename is the name of the xml file on disk WITHOUT the path or extension, such as ‘InventoryListSheet’.
      table is the name of the table (not the index).
      column is the name of the column (not the index).
Class (Enum) Reference
   A class reference column will show each cell with a drop-down selector. The selector gets its list from the members of a C# enum.
   To set a column up in thie manner, set its ‘Class Reference’ to the full C# name of the enum.
   The enum must be in the ProtoDBClasses.cs file.
   The enum may not be in a namespace.
   The enum may be nested inside classes (in which case you specify its name using a string such as ‘Class1.Class2.EnumName’).

When setting up a column type, a game developer may clear out all of the unrelated column type info. For example, if you change a column from a Filename to a Class Reference, remember to clear out the Filename Ext and Filename Path fields.

### Implementation Details

The code is heavily documented. The main classes are:
XMLSS.Workbook—This allows for round-trip serialization to/from Excel XMLSS files. Child objects and classes of this class allow for easy programmatic manipulation of the spreadsheet.
BaseSpreadsheetData—This class sits on top of a Workbook and handles things such as Unity's undo/redo.
SpreadsheetRenderer and SpreadsheetEditorWindow—Provides functions to render GUI widgets in the Unity editor.
Spreadsheets—This loads and manages the all BaseSpreadsheetData objects and caches column-to-column references to speed up the Renderer class.

### How-To

Add a simple spreadsheet file+editor pair:
Copy/paste the AnimalListData and AnimalListEditorWindow classes and rename the copies appropriately.
Change the menu item name and the Filename.
You're done!
Add a more complex editor that can edit multiple related sheets:
Refer to the QuestEditorWindow for a complete example.

### Overview of ProtoDB (e.g., the Real-time Database)

The new approach will have Proto classes with very shallow inheritance chains, and Interfaces to guarantee specific fields related to types of functionality to in-game Behaviours. This should alleviate the problem we have with shared fields across different Proto classes that inheritance alone cannot solve gracefully.

The ProtoDB will now have a master collection of all Proto classes, of base type ProtoData. Data retrieval can be done by checking Proto classes' datatypes and/or implementations using LINQ or traditional looping techniques. This will solve the problem of data retrieval when the entity type is unknown, which was a problem in the previous implementation involving discreet separation of proto data by concrete class type in their own collections.

Adding new Spreadsheet Data, Interfaces, and Concrete Classes

Adding new spreadsheets requires addressing 2 parts, and an optional third part—Spreadsheet data, ProtoData classes, and data Interfaces. Before we get to the actual “adding” instructions, a few things to get out of the way.

Naming Conventions
1. Concrete classes start with “Proto” to distinguish them from non-data classes, followed by the item type. Examples: ProtoCrop, ProtoAnimal
2. Protodata interfaces will follow the standard interface naming convention starting with “I”, and following with Proto<whatever>. Examples: IProtoMarketItem, IProtoHarvestable
3. Class and Interface names must be of a SINGULAR NOUN. Examples: ProtoSound, ProtoSetting, ProtoCrop, ProtoInventoryItem
4. Field names that describe time must indicate a PURPOSE and UNIT OF MEASUREMENT. Examples: constructionTimeSeconds, growthTimeDays, harvestDurationSeconds

### Concrete Classes and Interfaces

### Interfaces: Their Purpose, and a Caution About Their Use

Interfaces help us standardize the data available to certain functionality in the game. For example, Market has to display items described by a wide variety of proto classes, but requires the same data from all of them. To ensure that these classes will have the required data, they implement IProtoMarketItem, which lists the data expected by Market and forces the aforementioned concrete proto classes to define them. Use interfaces only if necessary. They should be seen as a fallback to unify data shared across multiple concrete proto classes. Chances are the interfaces you seek for your new proto class have already been defined and used by previous proto classes. Check the implementation below or ask around before creating a new one.

### Concrete Proto Classes

All concrete proto classes may inherit from ProtoData. Implementing interfaces is optional, but required if the new class describes an item that shares data and functionality with other concrete classes. Examples of classes that do not require implementing interfaces are setting classes like ProtoSound and ProtoSetting.

### Adding New Interfaces and Classes!

1. (Optional) If your new class is expected to share data with other present or future classes that have not already been defined in other interfaces, add a new interface with those data in either Assets/Plugins/Engine/Scripts/ProtoDB or Assets/Scripts/Game/ProtoDB, as appropriate. Look at another interface in that folder, like IProtoMarketItem, as an example.
2. Add the concrete class for holding the data to either the Assets/Plugins/Engine/Scripts/ProtoDB/ProtoDBClasses.cs file, or the Assets/Scripts/Game/ProtoDB/GameProtoClasses.cs file. It may extend from ProtoData, and can optionally extend multiple proto interfaces. Look at one of the other concrete proto classes, like ProtoRoyal, as an example.
3. Be sure your new class has the [ProtoContract] attribute on the class (telling it to be serializable), and [ProtoMember] attributes on any members you need serialized.
4. If you're adding an engine-level class, add a ProtoInclude metadata tag above the class definition of ProtoData within ProtoDBClasses.cs.
5. If you're adding a game-level class, add the [ProtoDerivedFromData] attribute to the class, giving it a unique number. (Our convention is that game-level classes are in the 200's).
6. Create a new class in the Assets/Scripts/Editor directory that maps the spreadsheet filename to the member component of the ProtoDB. (See RoyalListData as an example).
7. Create a new class in the Assets/Editor directory that hooks up an editor menu item to your spreadsheet data. (See RoyalListEditorWindow as an example).
8. Create a spreadsheet file in Assets/Data that's saved in XMLSS form, and make sure that the column names in row 1 match the data member fields. You can override this in the code with the SpreadsheetColumnName custom attribute, if needed. You can set up this spreadsheet either in Excel, or by manually editing the XMLSS; columns will be reflected in the in-Unity editor.

### Example Data Flow

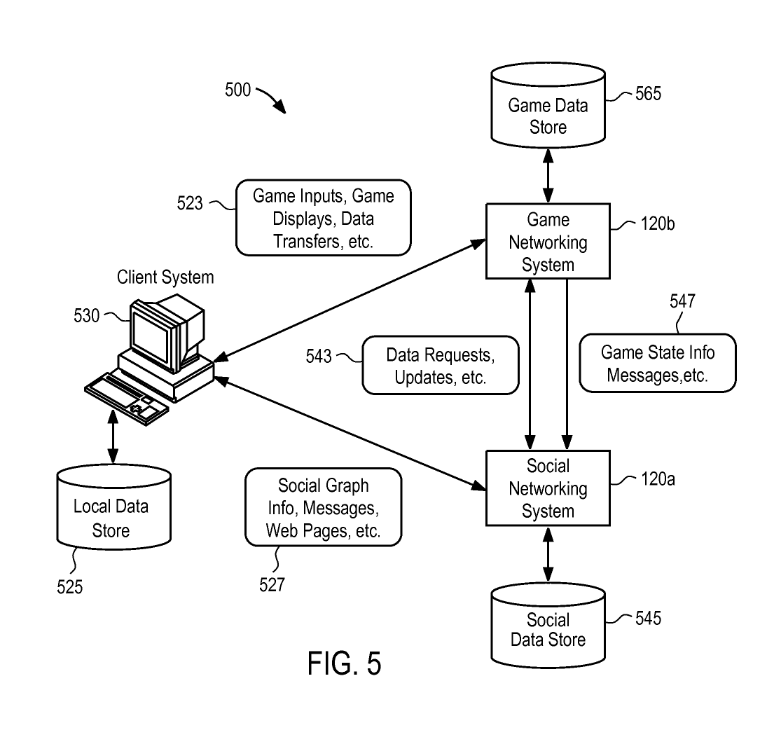

FIG. 5 illustrates an example data flow between the components of system 500. In particular embodiments, system 500 can include client system 530, social networking system 120a, and game networking system 120b. The components of system 500 can be connected to each other in any suitable configuration, using any suitable type of connection. The components may be connected directly or over any suitable network. Client system 530, social networking system 120a, and game networking system 120b can each have one or more corresponding data stores such as local data store 525, social data store 545, and game data store 565, respectively. Social networking system 120a and game networking system 120b can also have one or more servers that can communicate with client system 530 over an appropriate network. Social networking system 120a and game networking system 120b can have, for example, one or more internet servers for communicating with client system 530 via the Internet. Similarly, social networking system 120a and game networking system 120b can have one or more mobile servers for communicating with client system 530 via a mobile network (e.g., GSM, PCS, Wi-Fi, WPAN, and the like). In some embodiments, one server may be able to communicate with client system 530 over both the Internet and a mobile network. In other embodiments, separate servers can be used.

Client system 530 can receive and transmit data 523 to and from game networking system 120b. This data can include, for example, webpages, messages, game inputs, game displays, HTTP packets, data requests, transaction information, updates, and other suitable data. At some other time, or at the same time, game networking system 120b can communicate data 543, 547 (e.g., game state information, game system account information, page info, messages, data requests, updates, and so forth) with other networking systems, such as social networking system 120a (e.g., Facebook®, Myspace, and the like). Client system 530 can also receive and transmit data 527 to and from social networking system 120a. This data can include, for example, webpages, messages, social graph information, social network displays, HTTP packets, data requests, transaction information, updates, and other suitable data.

Communication between client system 530, social networking system 120a, and game networking system 120b can occur over any appropriate electronic communication medium or network using any suitable communications protocols. For example, client system 530, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols. In addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 120b, the BLOB containing the game state for the instance corresponding to the player can be transmitted to client system 530 for use by a client-side executed object to process. In particular embodiments, the client-side executable may be a FLASH-based game, which can de-serialize the game state data in the BLOB. As a player plays the game, the game logic implemented at client system 530 maintains and modifies the various game state parameters locally. The client-side game logic may also batch game events, such as mouse clicks, and transmit these events to game networking system 120b. Game networking system 120b may itself operate by retrieving a copy of the BLOB from a database or an intermediate memory cache (memcache) layer. Game networking system 120b can also de-serialize the BLOB to resolve the game state parameters and execute its own game logic based on the events in the batch file of events transmitted by the client to synchronize the game state on the server side. Game networking system 120b may then re-serialize the game state, now modified, into a BLOB and pass this to a memory cache layer for lazy updates to a persistent database.

With a client-server environment in which the online games may run, one server system, such as game networking system 120b, may support multiple client systems 530. At any given time, there may be multiple players at multiple client systems 530, all playing the same online game. In practice, the number of players playing the same game at the same time may be very large. As the game progresses with each player, multiple players may provide different inputs to the online game at their respective client systems 530, and multiple client systems 530 may transmit multiple player inputs and/or game events to game networking system 120b for further processing. In addition, multiple client systems 530 may transmit other types of application data to game networking system 120b.

In particular embodiments, a computer-implemented game may be a text-based or turn-based game implemented as a series of web pages that are generated after a player selects one or more actions to perform. The web pages may be displayed in a browser client executed on client system 530. As an example and not by way of limitation, a client application downloaded to client system 530 may operate to serve a set of webpages to a player. As another example and not by way of limitation, a computer-implemented game may be an animated or rendered game executable as a stand-alone application or within the context of a webpage or other structured document. In particular embodiments, the computer-implemented game may be implemented using Adobe Flash-based technologies. As an example and not by way of limitation, a game may be fully or partially implemented as a SWF (Small Web Format) object that is embedded in a web page and executable by a Flash media player plug-in. In particular embodiments, one or more described webpages may be associated with or accessed by social networking system 120a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 530, either caused by an action of a game player or by the game logic itself, client system 530 may need to inform game networking system 120b of the update. For example, if the game is a farming game with a harvest mechanic (such as Zynga® FarmVille), an event can correspond to a player clicking on a parcel of land to harvest a crop. In such an instance, the application event data may identify an event or action (e.g., harvest) and an object in the game to which the event or action applies. For illustration purposes and not by way of limitation, system 500 is discussed in reference to updating a multi-player online game hosted on a network-addressable system (such as, for example, social networking system 120a or game networking system 120b), where an instance of the online game is executed remotely on a client system 530, which then transmits application event data to the hosting system such that the remote game server synchronizes game state associated with the instance executed by the client system 530.

In particular embodiments, one or more objects of a game may be represented as an Adobe® Flash (or other authoring environment, such as HTML5) object. Flash may manipulate vector and raster graphics, and supports bidirectional streaming of audio and video. “Flash” may mean the authoring environment, the player, or the application files. In particular embodiments, client system 530 may include a Flash client. The Flash client may be configured to receive and run Flash application or game object code from any suitable networking system (such as, for example, social networking system 120a or game networking system 120b). In particular embodiments, the Flash client may be run in a browser client executed on client system 530. A player can interact with Flash objects using client system 530 and the Flash client. The Flash objects can represent a variety of in-game objects. Thus, the player may perform various in-game actions on various in-game objects by make various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 530, the Flash client may send the events that caused the game state changes to the in-game object to game networking system 120b. However, to expedite the processing and hence the speed of the overall gaming experience, the Flash client may collect a batch of some number of events or updates into a batch file. The number of events or updates may be determined by the Flash client dynamically or determined by game networking system 120b based on server loads or other factors. For example, client system 530 may send a batch file to game networking system 120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at client system 530. In particular embodiments, the batch file may be a text file and the name-value pairs may be in string format.

In particular embodiments, when a player plays an online game on client system 530, game networking system 120b may serialize all the game-related data, including, for example and without limitation, game states, game events, user inputs, for this particular user and this particular game into a BLOB and stores the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, game networking system 120b may retrieve the corresponding BLOB from the database to determine the most-recent values of the game-related data. In particular embodiments, while a player is playing the online game, game networking system 120b may also load the corresponding BLOB into a memory cache so that the game system may have faster access to the BLOB and the game-related data contained therein.

### Example Network Systems

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

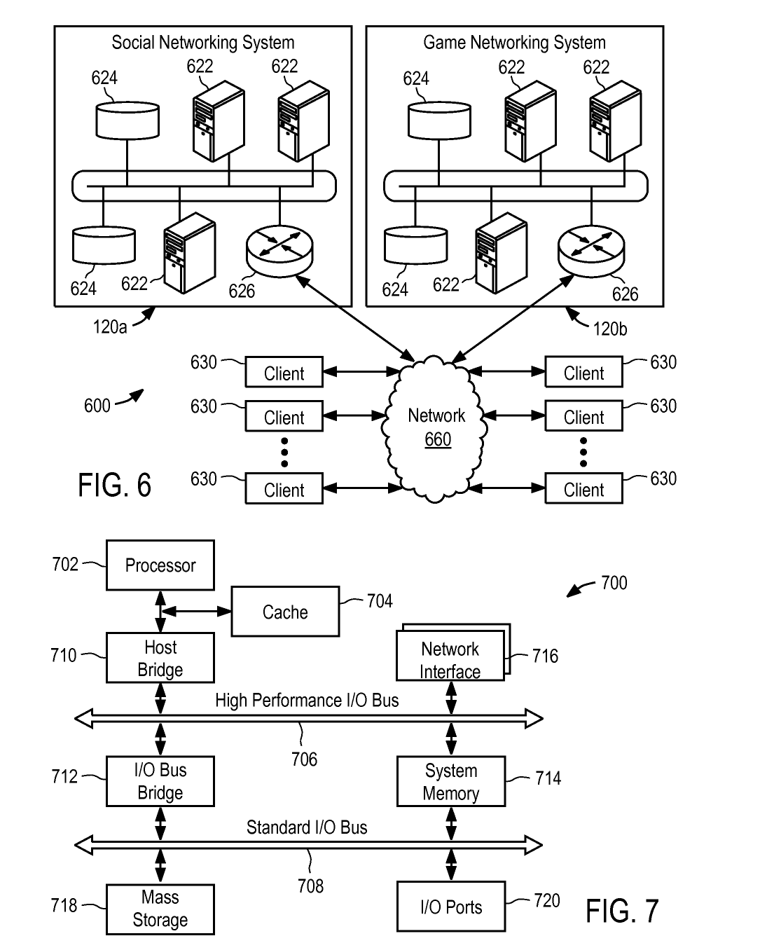

Particular embodiments may operate in a wide area network environment, such as the Internet, including multiple network addressable systems. FIG. 6 illustrates an example network environment, in which various example embodiments may operate. Network cloud 660 generally represents one or more interconnected networks, over which the systems and hosts described herein can communicate. Network cloud 660 may include packet-based wide area networks (such as the Internet), private networks, wireless networks, satellite networks, cellular networks, paging networks, and the like. As FIG. 6 illustrates, particular embodiments may operate in a network environment comprising one or more networking systems, such as social networking system 120a, game networking system 120b, and one or more client systems 630. The components of social networking system 120a and game networking system 120b operate analogously; as such, hereinafter they may be referred to simply at networking system 620. Client systems 630 are operably connected to the network environment via a network service provider, a wireless carrier, or any other suitable means.

Networking system 620 is a network addressable system that, in various example embodiments, comprises one or more physical servers 622 and data stores 624. The one or more physical servers 622 are operably connected to computer network 660 via, by way of example, a set of routers and/or networking switches 626. In an example embodiment, the functionality hosted by the one or more physical servers 622 may include web or HTTP servers, FTP servers, as well as, without limitation, webpages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), Flash, ActionScript, and the like.

Physical servers 622 may host functionality directed to the operations of networking system 620. Hereinafter servers 622 may be referred to as server 622, although server 622 may include numerous servers hosting, for example, networking system 620, as well as other content distribution servers, data stores, and databases. Data store 624 may store content and data relating to, and enabling, operation of networking system 620 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like. Logically, data store 624 corresponds to one or more of a variety of separate and integrated databases, such as relational databases and object-oriented databases, that maintain information as an integrated collection of logically related records or files stored on one or more physical systems. Structurally, data store 624 may generally include one or more of a large class of data storage and management systems. In particular embodiments, data store 624 may be implemented by any suitable physical system(s) including components, such as one or more database servers, mass storage media, media library systems, storage area networks, data storage clouds, and the like. In one example embodiment, data store 624 includes one or more servers, databases (e.g., MySQL), and/or data warehouses. Data store 624 may include data associated with different networking system 620 users and/or client systems 630.

Client system 630 is generally a computer or computing device including functionality for communicating (e.g., remotely) over a computer network. Client system 630 may be a desktop computer, laptop computer, personal digital assistant (PDA), in- or out-of-car navigation system, smart phone or other cellular or mobile phone, or mobile gaming device, among other suitable computing devices. Client system 630 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 630 to enter addresses of specific network resources to be retrieved, such as resources hosted by networking system 620. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the webpages and provide an automated way for the user to enter the URL of another page and to retrieve that page.

A webpage or resource embedded within a webpage, which may itself include multiple embedded resources, may include data records, such as plain textual information, or more complex digitally encoded multimedia content, such as software programs or other code objects, graphics, images, audio signals, videos, and so forth. One prevalent markup language for creating webpages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a webpage may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 630 desires to view a particular webpage (hereinafter also referred to as a target structured document) hosted by networking system 620, the user's web browser, or other document rendering engine or suitable client application, formulates and transmits a request to networking system 620. The request generally includes a URL or other document identifier as well as metadata or other information. By way of example, the request may include information identifying the user, such as a user ID, as well as information identifying or characterizing the web browser or operating system running on the user's client computing device 630. The request may also include location information identifying a geographic location of the user's client system or a logical network location of the user's client system. The request may also include a timestamp identifying when the request was transmitted.

Although the example network environment described above and illustrated in FIG. 6 is described with respect to social networking system 120a and game networking system 120b, this disclosure encompasses any suitable network environment using any suitable systems. As an example and not by way of limitation, the network environment may include online media systems, online reviewing systems, online search engines, online advertising systems, or any combination of two or more such systems.

### Example Computer System

FIG. 7 illustrates an example computing system architecture, which may be used to implement a server 622 or a client system 630. In one embodiment, a hardware system 700 comprises a processor 702, a cache memory 704, and one or more executable modules and drivers, stored on a tangible computer readable medium, directed to the functions described herein. Additionally, hardware system 700 may include a high performance input/output (I/O) bus 706 and a standard I/O bus 708. A host bridge 710 may couple processor 702 to high performance I/O bus 706, whereas I/O bus bridge 712 couples the two buses 706 and 708 to each other. A system memory 714 and one or more network/communication interfaces 716 may couple to bus 706. Hardware system 700 may further include video memory (not shown) and a display device coupled to the video memory. Mass storage 718 and I/O ports 720 may couple to bus 708. Hardware system 700 may optionally include a keyboard, a pointing device, and a display device (not shown) coupled to bus 708. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 700 are described in greater detail below. In particular, network interface 716 provides communication between hardware system 700 and any of a wide range of networks, such as an Ethernet (e.g., IEEE 802.3) network, a backplane, and so forth. Mass storage 718 provides permanent storage for the data and programming instructions to perform the above-described functions implemented in servers 522, whereas system memory 714 (e.g., DRAM) provides temporary storage for the data and programming instructions when executed by processor 702. I/O ports 720 are one or more serial and/or parallel communication ports that provide communication between additional peripheral devices, which may be coupled to hardware system 700.

Hardware system 700 may include a variety of system architectures and various components of hardware system 700 may be rearranged. For example, cache 704 may be on-chip with processor 702. Alternatively, cache 704 and processor 702 may be packed together as a “processor module,” with processor 702 being referred to as the “processor core.” Furthermore, certain embodiments of the present disclosure may not require nor include all of the above components. For example, the peripheral devices shown coupled to standard I/O bus 708 may couple to high performance I/O bus 706. In addition, in some embodiments, only a single bus may exist, with the components of hardware system 700 being coupled to the single bus. Furthermore, hardware system 700 may include additional components, such as additional processors, storage devices, or memories.

An operating system manages and controls the operation of hardware system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, and the like), that makes API calls directly to a server. Still further, while the embodiments described above operate with business-related virtual objects (such as stores and restaurants), the invention can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
receiving an update to a value in at least one cell of a table in an editable document, wherein each cell of the table maps to a property of a class definition for a game asset of a virtual online game;
in an automated operation using one or more processors, modifying at least one property of the class definition that maps to the at least one cell that received the update to the value;
serializing data representative of the modified property; and
sending the serialized data to a client system for instantiation of the game asset having the modified property.

2. The computer-implemented method of claim 1, wherein receiving an update to a value in at least one cell of a table in an editable document comprises:
receiving a first request to access stored editable document cell data;
sending the editable document cell data to populate an editable document formatted according to an external format;
receiving a first update for a first cell in the externally-formatted editable document; and
storing the first update in the stored editable document cell data.

3. The computer-implemented method of claim 2, wherein receiving an update to a value in at least one cell of a table in an editable document comprises:
receiving a second request to access stored editable document cell data;
sending the editable document cell data to populate an editable document formatted according to a native format;
receiving a second update for the first update populated in the natively-formatted editable document; and
storing the second update in the stored editable document cell data.

4. The computer-implemented method of claim 3, wherein receiving an update to a value in at least one cell of a table in an editable document comprises:
wherein the first update comprises a first address to a first image file received from a first user; and
wherein the second update comprises a second address to a second image file received from a second user.

5. The computer-implemented method of claim 4, further comprising:
wherein the first and second image files each comprise respective a graphic for an icon of a virtual object in a farm harvesting virtual online game.

6. The computer-implemented method of claim 1, wherein serializing data representative of the modified property comprises:
formatting data representative of the modified property according to a run-time format compatible with a client system.

7. A machine-readable storage medium storing instructions which, when executed by one or more processors, cause the one or more processors to perform operations comprising:
receiving an update to a value in at least one cell of a table in an editable document, wherein each cell of the table maps to a property of a class definition for a game asset of a virtual online game;
modifying at least one property of the class definition that maps to the at least one cell that received the update to the value;
serializing data representative of the modified property; and
sending the serialized data to a client system for instantiation of the game asset having the modified property.

8. The machine-readable storage medium of claim 7, wherein receiving an update to a value in at least one cell of a table in an editable document comprises:
receiving a first request to access stored editable document cell data;
sending the editable document cell data to populate an editable document formatted according to an external format;
receiving a first update for a first cell in the externally-formatted editable document; and
storing the first update in the stored editable document cell data.

9. The machine-readable storage medium of claim 8, wherein receiving an update to a value in at least one cell of a table in an editable document comprises:
receiving a second request to access stored editable document cell data;
sending the editable document cell data to populate an editable document formatted according to a native format;
receiving a second update for the first update populated in the natively-formatted editable document; and
storing the second update in the stored editable document cell data.

10. The machine-readable storage medium of claim 9, wherein receiving an update to a value in at least one cell of a table in an editable document comprises:
wherein the first update comprises a first address to a first image file received from a first user; and
wherein the second update comprises a second address to a second image file received from a second user.

11. The machine-readable storage medium of claim 10, further comprising:
wherein the first and second image files each comprise respective a graphic for an icon of a virtual object in a farm harvesting virtual online game.

12. The machine-readable storage medium of claim 7, wherein serializing data representative of the modified property comprises:
formatting data representative of the modified property according to a run-time format compatible with a client system.

13. A computer system comprising:
a processor;
a memory device holding an instruction set executable on the processor to cause the computer system to perform operations comprising:
receiving an update to a value in at least one cell of a table in an editable document, wherein each cell of the table maps to a property of a class definition for a game asset of a virtual online game;
modifying at least one property of the class definition that maps to the at least one cell that received the update to the value;
serializing data representative of the modified property; and
sending the serialized data to a client system for instantiation of the game asset having the modified property.

14. The computer system of claim 13, wherein receiving an update to a value in at least one cell of a table in an editable document comprises:
receiving a first request to access stored editable document cell data;
sending the editable document cell data to populate an editable document formatted according to an external format;
receiving a first update for a first cell in the externally-formatted editable document; and
storing the first update in the stored editable document cell data.

15. The computer system of claim 14, wherein receiving an update to a value in at least one cell of a table in an editable document comprises:
receiving a second request to access stored editable document cell data;
sending the editable document cell data to populate an editable document formatted according to a native format;
receiving a second update for the first update populated in the natively-formatted editable document; and
storing the second update in the stored editable document cell data.

16. The computer system of claim 15, wherein receiving an update to a value in at least one cell of a table in an editable document comprises:
wherein the first update comprises a first address to a first image file received from a first user; and
wherein the second update comprises a second address to a second image file received from a second user.

17. The computer system of claim 16, further comprising:
wherein the first and second image files each comprise respective a graphic for an icon of a virtual object in a farm harvesting virtual online game.

18. The computer system of claim 13, wherein serializing data representative of the modified property comprises:
formatting data representative of the modified property according to a run-time format compatible with a client system.
